(19) United States
(12) Patent Application Publication
(10) Pub. No.: US 2026/0194931 A1
(43) Pub. Date: Jul. 9, 2026

(54) FLIPPED VOLTAGE FOLLOWER HAVING COMMON GATE ELECTRODE STAGE FEEDBACK

(71) Applicant: JOYWELL SEMICONDUCTOR (SHANGHAI) CO., LTD., Shanghai (CN)

(72) Inventors: Kaibo MIAO, Shanghai (CN); Minqing CAI, Shanghai (CN); Chen CHEN, Shanghai (CN); Seung Chul LEE, Shanghai (CN)

(21) Appl. No.: 19/128,551

(22) PCT Filed: Nov. 3, 2023
(86) PCT No.: PCT/CN2023/129674

§ 371 Date: May 8, 2025

(30) Foreign Application Priority Data
Nov. 11, 2022 (CN) 202211420866.9

(51) Int. Cl. G05F 1/575

(52) U.S. Cl. CPC G05F 1/575

(57) ABSTRACT

A flipped voltage follower having common gate electrode stage feedback, includes first to eleventh transistors and a tunable resistor. The source electrodes of the first to the third transistors are connected to a power supply end. The drain electrode of the first transistor and the gate electrodes of the first to the third transistors are connected to a first bias current source. The drain electrodes of the second and the fourth transistors, the source electrode of the sixth transistor and one end of the tunable resistor are connected. The source electrode of the fourth transistor is connected to the drain electrode of the eighth transistor. The gate electrodes of the sixth and the eighth transistors and the drain electrode and the gate electrode of the tenth transistor are connected. The drain electrodes of the third and the fifth transistor, the source electrode of the seventh transistor and the other end of the tunable resistor are connected.

### TECHNICAL FIELD

The present application relates to the technical field of integrated circuits, and in particular to a flipped voltage follower having common gate electrode stage feedback.

### BACKGROUND

The basic structure of the flipped voltage follower is shown in FIG. 1. The transistors M1, M2 and the current source Ib form a feedback loop. If the feedback loop is assumed to be cut off, when voltage of the input node Vi rises, voltage of the output node Vo also rises to maintain the IDS of the transistor M1 constant. This is the basic operation of a simple source follower. Now, assuming the feedback loop is opened, in addition to the direct signal path from Vi to Vo, there is an additional signal path from Vi to voltage node y, and then to Vo. With the help of the feedback loop, the effective transconductance (Gm) and bandwidth of the flipped voltage follower are much larger than those of the simple source follower. The basic flipped voltage follower has the following issues in mass production and practical applications.

1. The voltage node y is directly connected to the gate electrode of M2. In order to ensure that M1 and M2 stay in the saturation region, VGS2>Vdsat1+Vdsat2 should be maintained. This means a large VGS2 for M2, which implies a small W/L ratio and a large current density for M2. From the perspective of electromigration and aging effects in modern semiconductor technology, this is not advantageous.

2. The VGS2 is roughly equal to Vdsat 2+Vth2. In order to maintain VGS2>Vdsat1+Vdsat2, it is necessary to maintain Vth2>Vdsat1 across PVT corners. In practical applications, Vth2 may fluctuate greatly in a wide range across PVT, making it difficult to maintain Vth2>Vdsat1 in all scenarios.

### SUMMARY OF THE INVENTION

An object of the present application is to provide a flipped voltage follower having common gate electrode stage feedback, which provides more design freedom and robustness for the DC bias point design of the circuit.

The present application discloses a flipped voltage follower having common gate electrode stage feedback, comprising first to eleventh transistors and a tunable resistor, wherein:
source electrodes of the first to third transistors are connected to a power supply terminal, and a drain electrode of the first transistor and gate electrodes of the first to third transistors are connected together and connected to a first bias current source;
a drain electrode of the second transistor, a drain electrode of the fourth transistor, a source electrode of the sixth transistor, and one end of the tunable resistor are connected together, a source electrode of the fourth transistor is connected to a drain electrode of the eighth transistor, and a drain electrode of the sixth transistor, a gate electrode of the eighth transistor, and a drain electrode and a gate electrode of the tenth transistor are connected together;
a drain electrode of the third transistor, a drain electrode of the fifth transistor, a source electrode of the seventh transistor, and the other end of the tunable resistor are connected together, a source electrode of the fifth transistor is connected to a drain electrode of the ninth transistor, a drain electrode of the seventh transistor, a gate electrode of the ninth transistor, and a drain electrode and a gate electrode of the eleventh transistor are connected together, and source electrodes of the eighth to eleventh transistors are connected to a ground terminal;
Wherein, gate electrodes of the sixth and seventh transistors are connected to a bias voltage, and gate electrodes of the fourth and fifth transistors respectively receive differential input signals, and source electrodes of the fourth and fifth transistors respectively output differential output signals.

In a preferred embodiment, further comprising a bias voltage generation circuit comprising: twelfth to fifteenth transistors, a first resistor, and a second bias current source; wherein a gate electrode and a drain electrode of the twelfth transistor, and a gate electrode of the thirteenth transistor are connected to the second bias current source, a drain electrode of the thirteenth transistor, and a drain electrode and a gate electrode of the fourteenth transistor are connected together and output the bias voltage, a source electrode of the fourteenth transistor, one end of the first resistor, and a drain electrode and a gate electrode of the fifteenth transistor are connected together, the other end of the first resistor is connected to the power supply terminal, and a source electrode of the fifteenth transistor is connected to the power supply terminal.

In a preferred embodiment, the first bias current source and the second bias current source have a suitable current ratio relationship, and the twelfth transistor and the thirteenth transistor have a suitable size ratio relationship, so that current density of the fourteenth transistor is equal to source-drain current density of the sixth transistor and the seventh transistor.

In a preferred embodiment, the current ratio of the first bias current source and the second bias current source is 1:1, and the size ratio of the twelfth and thirteenth transistors is 1:1.

In a preferred embodiment, the twelfth and thirteenth transistors are NMOS transistors or PMOS transistors, and the fourteenth and fifteenth transistors are PMOS transistors or NMOS transistors.

In a preferred embodiment, further comprising a first capacitor, one end of the first capacitor is connected to the source electrode of the fourth transistor and the drain electrode of the eighth transistor, and the other end of the first capacitor is connected to the ground terminal.

In a preferred embodiment, further comprising a second capacitor, one end of the second capacitor is connected to the source electrode of the fifth transistor and the drain electrode of the ninth transistor, and the other end of the second capacitor is connected to the ground terminal.

In a preferred embodiment, the first to fourth transistors, the sixth transistor, and the seventh transistor are PMOS transistors or NMOS transistors, and the fourth transistor, the fifth transistor, and the eighth to eleventh transistors are NMOS transistors or PMOS transistors.

Compared to the basic flipped voltage follower, the improved technical effects of the present application include but are not limited to:
1. Enhancing the robustness of the DC operating point design of the circuit, making it relatively less sensitive to process corner and temperature variations;
2. Enhancing the flexibility of feedback loop design, allowing the circuit to achieve optimal stability, linearity, bandwidth, and power consumption by adjusting the resistance or current mirror ratio under different bias current sources and power supply voltages;
3. The feedback loop of the present application does not use an AC coupling capacitor structure, but adopts a DC coupling method. This avoids introducing large AC coupling capacitors and saves layout area in practical integrated circuit applications.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a schematic diagram of a flipped voltage follower in the prior art.

FIG. 2 is a schematic diagram of a flipped voltage follower according to an embodiment of the present application.

FIG. 3 is a schematic diagram of a bias circuit according to an embodiment of the present application.

FIG. 4 shows the voltage at the drain electrode with and without clamp device input under different temperature conditions for fast NMOS, fast PMOS, low power supply voltage.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

In order to make the objects, technical solutions and advantages of the present application clearer, embodiments of the present application will be further described in detail below with reference to the accompanying drawings.

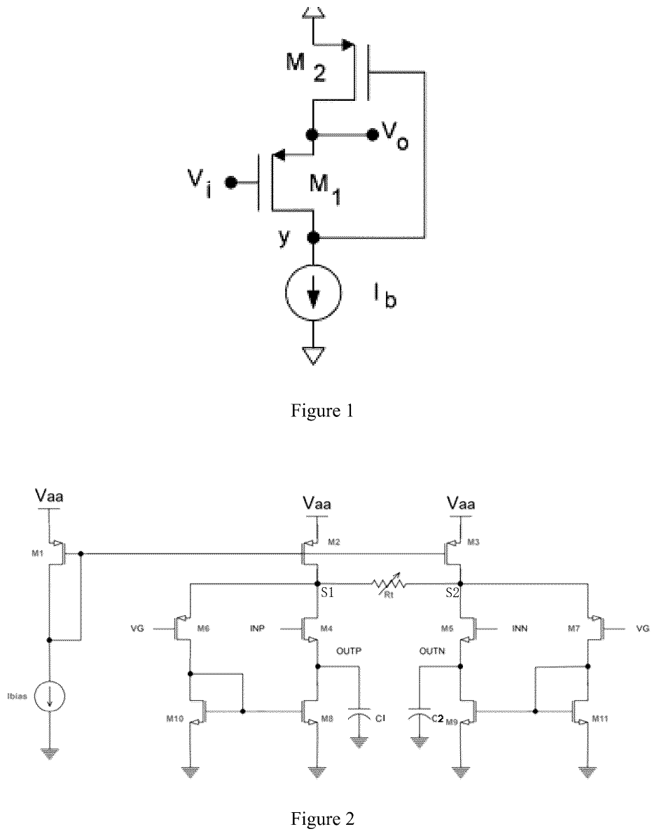

The present application discloses a flipped voltage follower having common gate electrode stage feedback. FIG. 2 shows a schematic diagram of a flipped voltage follower in one embodiment, which includes a first transistor M1, a second transistor M2, a third transistor M3, a fourth transistor M4, a fifth transistor M5, a sixth transistor M6, a seventh transistor M7, an eighth transistor M8, a ninth transistor M9, a tenth transistor M10, an eleventh transistor M11, and a tunable resistor Rt. In one embodiment, the first transistor M1, the second transistor M2, the third transistor M3, the sixth transistor M6, and the seventh transistor M7 may be PMOS transistors. The fourth transistor M4, the fifth transistor M5, the eighth transistor M8, the ninth transistor M9, the tenth transistor M10, and the eleventh transistor M11 may be NMOS transistors. In another embodiment, the first transistor M1, the second transistor M2, the third transistor M3, the sixth transistor M6, and the seventh transistor M7 may be NMOS transistors. The fourth transistor M4, the fifth transistor M5, the eighth transistor M8, the ninth transistor M9, the tenth transistor M10, and the eleventh transistor M11 may be PMOS transistors.

Wherein, the source electrodes of the first transistor M1, the second transistor M2, and the third transistor M3 are connected to the power supply terminal Vaa, and the drain electrode of the first transistor MI and the gate electrodes of the first transistor M1, the second transistor M2, and the third transistor M3 are connected together and connected to the first bias current source Ibias.

Furthermore, the drain electrode of the second transistor M2, the drain electrode of the fourth transistor M4, the source electrode of the sixth transistor M6, and one end of the tunable resistor Rt are connected to the first node S1. The source electrode of the fourth transistor M4 is connected to the drain electrode of the eighth transistor M8, and the drain electrode of the sixth transistor M6, the gate electrode of the eighth transistor M8, and the drain electrode and the gate electrode of the tenth transistor M10 are connected together. Similarly, the drain electrode of the third transistor M3, the drain electrode of the fifth transistor M5, the source electrode of the seventh transistor M7, and the other end of the tunable resistor Rt are connected to the second node S2, the source electrode of the fifth transistor M5 is connected to the drain electrode of the ninth transistor M9, the drain electrode of the seventh transistor M7, the gate electrode of the ninth transistor M9, and the drain electrode and the gate electrode of the eleventh transistor M11 are connected together, and the source electrodes of the eighth transistor M8, the ninth transistor M9, the tenth transistor M10, and the eleventh transistor M11 are connected to the ground terminal. Wherein, the gate electrodes of the sixth transistor M6 and the seventh transistor M7 are connected to a bias voltage VG. The present application enables both the transistor M4 and the transistor M2 to stay in the saturation operating region.

The gate electrodes of the fourth transistor M4 and the fifth transistor M5 respectively receive differential input signals, and the source electrodes of the fourth transistor M4 and the fifth transistor M5 respectively output differential output signals. Specifically, the gate electrode of the fourth transistor M4 receives a positive input signal INP, the source electrode of the fourth transistor M4 outputs a positive differential output signal OUTP, the gate electrode of the fifth transistor M5 receives a negative input signal INN, and the source electrode of the fifth transistor M5 outputs a negative differential output signal OUTN.

In one embodiment, the flipped voltage follower further comprises a first capacitor C1, one end of which is connected to the source electrode of the fourth transistor M4 and the drain electrode of the eighth transistor M8, and the other end is connected to the ground terminal.

In a preferred embodiment, the flipped voltage follower further comprises a second capacitor C2, one end of which is connected to the source electrode of the fifth transistor M5 and the drain electrode of the ninth transistor M9, and the other end is connected to the ground terminal.

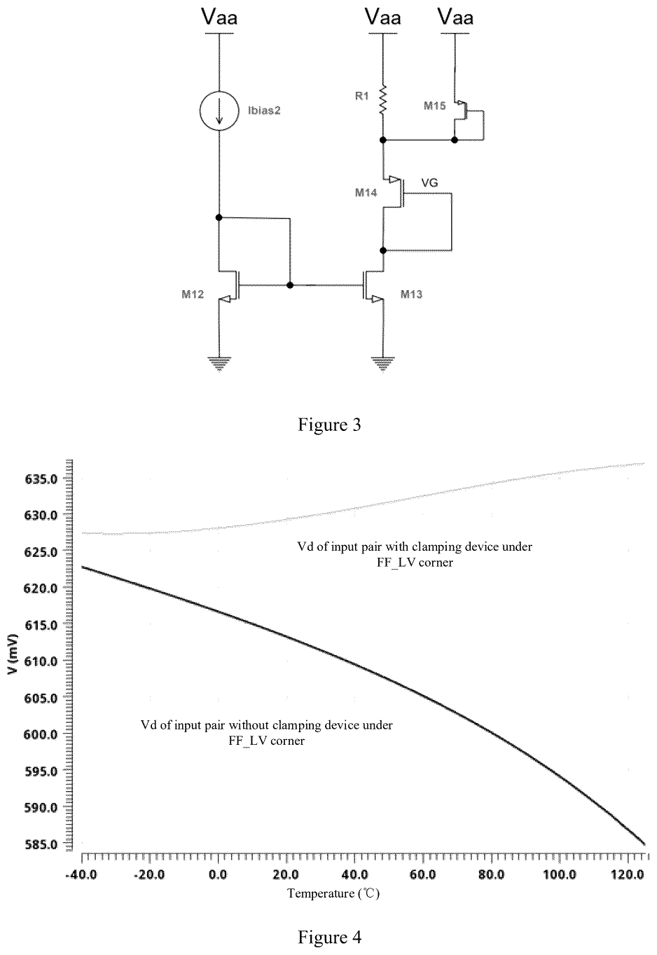

In one embodiment, the flipped voltage follower further comprises a bias voltage generation circuit. FIG. 3 shows a schematic diagram of the bias voltage generation circuit in one embodiment. The bias voltage generation circuit comprises a twelfth transistor M12, a thirteenth transistor M13, a fourteenth transistor M14, a fifteenth transistor M15, a first resistor R1, and a second bias current source Ibias2. In one embodiment, the twelfth transistor M12 and the thirteenth transistor M13 may be NMOS transistors, and the fourteenth transistor M14 and the fifteenth transistor M15 may be PMOS transistors. In another embodiment, the twelfth transistor M12 and the thirteenth transistor M13 may be PMOS transistors, and the fourteenth transistor M14 and the fifteenth transistor M15 may be NMOS transistors.

The gate electrode voltage of the transistors M6 and M7 is derived from the bias voltage generation circuit in the preferred embodiment. The bias voltage generation circuit has process corner and temperature compensation functions, making the gate electrode voltage of transistor M6 less sensitive to different process corners and operating temperatures, enhancing the robustness of the main circuit.

Wherein, the gate electrode and the drain electrode of the twelfth transistor M12, the gate electrode of the thirteenth transistor M13 are connected to the second bias current source Ibias2, the drain electrode of the thirteenth transistor M13, the drain electrode and the gate electrode of the fourteenth transistor M14 are connected together and output the bias voltage VG, the source electrode of the fourteenth transistor M14, one end of the first resistor R1, and the drain electrode and the gate electrode of the fifteenth transistor M15 are connected together, the other end of the first resistor RI is connected to the power supply terminal Vaa, and the source electrode of the fifteenth transistor M15 is connected to the power supply terminal Vaa.

In one embodiment, the first bias current source Ibias and the second bias current source Ibias2 have a suitable current ratio relationship, and the twelfth transistor M12 and the thirteenth transistor M13 have a suitable size ratio relationship, such that the current density of the fourteenth transistor M14 is equal to the source-drain current density of the sixth transistor M6 and the seventh transistor M7. For example, the current ratio of the first bias current source and the second bias current source is 1:1, and the size ratio of the twelfth and thirteenth transistors is 1:1, so that the current density (IDS/W) of the sixth transistor M6, the seventh transistor M7, and the fourteenth transistor M14 is equal.

The feedback loop in the main circuit consists of the tunable resistor Rt, the sixth transistor M6, the tenth transistor M10, and the eighth transistor M8. Among them, the tenth transistor M10 and the eighth transistor M8 form a current mirror. The loop gain of the feedback loop can be adjusted by adjusting the resistance value of Rt or the current mirror ratio composed of the transistors M10/M8 (W/L ratio of the transistors M10/M8). Usually in the design, the loop gain is adjusted to a larger value while ensuring stability, so that the main circuit has the characteristics of high bandwidth, high linearity and controllable stability.

In order to better understand the technical solutions of this specification, the following description will be given with a specific embodiment. The details listed in this embodiment are mainly for ease of understanding and are not intended to limit the scope of protection of the present application.

The circuit proposed in the present application is a fully differential circuit, as shown in FIG. 2. A pair of differential input signals are input to the gate electrode nodes of the transistors M4 and M5. The source electrode nodes of the transistors M4 and M5 output a pair of differential output signals.

Compared with the basic flipped voltage follower, the flipped voltage follower proposed in the present application has three additional devices on half of the differential circuit. These additional devices are the transistors M6, M10, and the resistor Rt (or M7, M11, and Rt). The transistor M6 is connected as a common gate electrode stage, and its electrically connected transistor M10 serves as its load. The transistors M10 and M8 form a current mirror. The tunable resistor Rt is a tunable resistor used to control the loop gain of the feedback loop.

The two additional transistors in the feedback loop (e.g. the transistors M6 and M10) provide more freedom in the design of the DC bias point for the circuit. By adjusting the gate electrode voltage (VG) of the transistor M6, the drain electrode voltage of the transistor M4 can be correspondingly adjusted. Adjusting the gate electrode voltage VG has little effect on the VGS of the transistor M8.

In summary, the proposed flipped voltage follower breaks the coupling between VGS-M8 and VDS_M8+VDS_M4 (in the basic flipped voltage follower, VGS-M8=VDS_M8+VDS_M4). In addition, the proposed circuit provides a method for generating bias voltage VG (gate electrode bias voltage of the transistors M6 and M7). As shown in FIG. 3, assuming the current mirror ratio of the transistors M12 and M13 is 1:1, then

$$VG = Vaa - R 1 * Ibias 2 - \vert VGS\_M14 \vert$$

Among them, the current source Ibias2 is proportional to the current source Ibias, and the transistor M14 is a proportional replica of the transistors M6 and M7. Under the first-order approximation, VGS_M14=VGS_M6=VGS_M7.

The source electrode voltage of the transistors M14, M6 and M7 is determined by adjusting Ibias2 * R1. If Ibias2 * R1 is too small, the voltage of the source electrode of the transistors M6 and M7 is too high, causing the VDS of the transistors M2 and M3 to be too small, pushing them into linear region. If Ibias2 * R1 is too large, the voltage of the source electrode of the transistors M6 and M7 is too low, causing the VDS of the transistors M4 and M5 to be too small, pushing them into linear region. Therefore, it is crucial to design Ibias2 * R1 properly so that the transistors M2, M3, M4, and M5 have sufficient voltage margin or headroom simultaneously.

Under FF_HT LV (fast NMOS/fast PMOS, high temperature, low power supply voltage) corner, Ibias2 * R1 may become larger than its nominal value, causing VG to become lower to squeeze the voltage margin of the transistors M4 and M5.

In order to improve the voltage margin of the transistors M4 and M5 Under FF HT-LV (fast NMOS/fast PMOS, high temperature, low power supply voltage) corner, the present application adds a clamp device (M15) in parallel with R1. Under FF-HT (fast NMOS/fast PMOS, high temperature) corner, the threshold voltage Vth of the clamp device M15 becomes lower, and its IDS becomes larger at this corner and pulls up the bias voltage VG to compensate the effect of the resistor R1. In summary, the resistor RI has a positive temperature coefficient, while Vth of the transistor M15 has a negative first-order temperature coefficient, which can compensate for each other to obtain a relatively stable bias voltage. FIG. 4 shows the voltage Vd (i.e., the voltage at nodes S1 and S2) under FF_LV (fast NMOS/fast PMOS, low power supply voltage) with and without clamp device input at different temperatures. It can be seen from the figure that the transistor voltage remains stable with temperature changes after using the clamp device.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises a multiple elements includes not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

The specification includes combinations of the various embodiments described herein. Separate references to embodiments (such as “an embodiment” or “some embodiments” or “preferred embodiments”) do not necessarily refer to the same embodiment; however, these embodiments are not mutually exclusive unless indicated as mutually exclusive or clearly mutually exclusive by those skilled in the art. It should be noted that unless the context clearly indicates or requires otherwise, the word “or” is used in this specification in a non-exclusive sense.

All documents mentioned in this specification are considered to be included in the disclosure of the present application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

1. A flipped voltage follower having common gate electrode stage feedback, comprising first to eleventh transistors, and a tunable resistor, wherein:
source electrodes of the first to third transistors are connected to a power supply terminal, and a drain electrode of the first transistor and gate electrodes of the first to third transistors are connected together and connected to a first bias current source;
a drain electrode of the second transistor, a drain electrode of the fourth transistor, a source electrode of the sixth transistor, and one end of the tunable resistor are connected together, a source electrode of the fourth transistor is connected to a drain electrode of the eighth transistor, and a drain electrode of the sixth transistor, a gate electrode of the eighth transistor, and a drain electrode and a gate electrode of the tenth transistor are connected together;
a drain electrode of the third transistor, a drain electrode of the fifth transistor, a source electrode of the seventh transistor, and the other end of the tunable resistor are connected together, a source electrode of the fifth transistor is connected to a drain electrode of the ninth transistor, a drain electrode of the seventh transistor, a gate electrode of the ninth transistor, and a drain electrode and a gate electrode of the eleventh transistor are connected together, and source electrodes of the eighth to eleventh transistors are connected to a ground terminal;
wherein, gate electrodes of the sixth and seventh transistors are connected to a bias voltage, and gate electrodes of the fourth and fifth transistors respectively receive differential input signals, and source electrodes of the fourth and fifth transistors respectively output differential output signals.

2. The flipped voltage follower of claim 1, further comprising a bias voltage generation circuit comprising: twelfth to fifteenth transistors, a first resistor, and a second bias current source; wherein a gate electrode and a drain electrode of the twelfth transistor, and a gate electrode of the thirteenth transistor are connected to the second bias current source, a drain electrode of the thirteenth transistor, and a drain electrode and a gate electrode of the fourteenth transistor are connected together and output the bias voltage, a source electrode of the fourteenth transistor, one end of the first resistor, and a drain electrode and a gate electrode of the fifteenth transistor are connected together, the other end of the first resistor is connected to the power supply terminal, and a source electrode of the fifteenth transistor is connected to the power supply terminal.

3. The flipped voltage follower of claim 2, wherein the first bias current source and the second bias current source have a suitable current ratio relationship, and the twelfth transistor and the thirteenth transistor have a suitable size ratio relationship, so that current density of the fourteenth transistor is equal to source-drain current density of the sixth transistor and the seventh transistor.

4. The flipped voltage follower of claim 3, wherein the current ratio of the first bias current source and the second bias current source is 1:1, and the size ratio of the twelfth and thirteenth transistors is 1:1.

5. The flipped voltage follower of claim 2, wherein the twelfth and thirteenth transistors are NMOS transistors, and the fourteenth and fifteenth transistors are PMOS transistors.

6. (canceled)

7. The flipped voltage follower of claim 2, wherein the twelfth and thirteenth transistors are PMOS transistors, and the fourteenth and fifteenth transistors are NMOS transistors.

8. The flipped voltage follower of claim 1, wherein the first to third transistors, the sixth transistor, and the seventh transistor are PMOS transistors, and the fourth transistor, the fifth transistor, and the eighth to eleventh transistors are NMOS transistors.

9. The flipped voltage follower of claim 1, wherein the first to third transistors, the sixth transistor, and the seventh transistor are NMOS transistors, and the fourth transistor, the fifth transistor, and the eighth to eleventh transistors are PMOS transistors.
